(19) United States
(12) Patent Application Publication
(10) Pub. No.: US 2012/0248316 A1
(43) Pub. Date: Oct. 4, 2012

(54) FRESNEL COMPOSITE LENS AND INFRARED TOUCH CONTROL DEVICE USING THE SAME

(75) Inventors: KUN LIANG, Shenzhen City (CN); TSANG-CHIANG YANG, Tu-Cheng (TW); JIAN YUAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/272,230

(22) Filed: Oct. 13, 2011

(30) Foreign Application Priority Data
Apr. 2, 2011 (CN) 201110083763.3

(51) Int. Cl. G01J 5/08; G02B 3/08

(52) U.S. Cl. 250/353; 359/742

(57) ABSTRACT

A Fresnel composite lens for used in an infrared touch control device including a number of infrared emitters and an infrared receiver. The Fresnel composite lens includes a number of Fresnel lens portions having a plurality of parallel optical axes, each Fresnel lens portion having a corresponding optical axis. Each Fresnel lens portion corresponds to a particular emitter and is configured for converging and directing light from a corresponding infrared emitter to the infrared receiver. The Fresnel lens portions are configured for focusing the light from the respective infrared emitters at a common point located on the infrared receiver.

### BACKGROUND

1. Technical Field

The present disclosure relates to touch control devices, particularly, to an infrared touch control device incorporating a Fresnel composite lens.

2. Description of Related Art

Referring to FIG. 1, an infrared touch control device 100′ is illustrated. The infrared touch control device 100′ includes a number of infrared emitters 20′ and a infrared receiver 30′ arranged opposite to the infrared emitters 20′. In this layout, the light emitted by the infrared emitters 20′ becomes scattered, which cannot be received precisely by the infrared receiver 30′, and the total size of the area where a touch may be detected is also restricted by the acceptance angle of the infrared receiver 30′. Furthermore, there is not a standard distance between the infrared receiver 30′ and each of the infrared emitters 20′, which will lead to different strengths of light reaching the infrared receiver 30′, which has a negative influence on the processing result of the infrared touch control device 100′. Therefore, an infrared touch control device incorporating a Fresnel composite lens is needed.

### BRIEF DESCRIPTION OF THE DRAWINGS

Many aspects of the embodiments can be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a schematic view of an infrared touch control device.

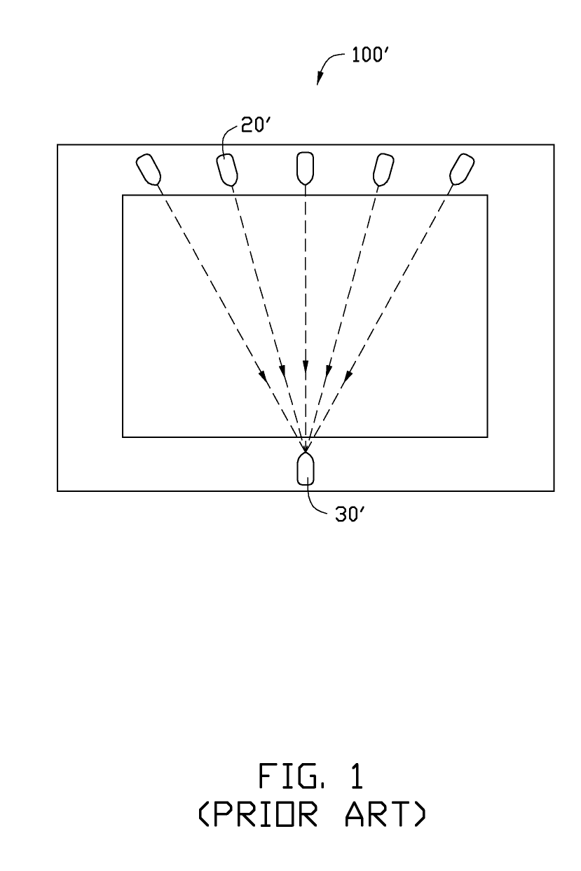

FIG. 2 is an infrared touch control device according to an embodiment.

FIG. 3 is an isometric view showing the Fresnel composite lens of the infrared touch control device of FIG. 2 from a first perspective.

FIG. 4 is an isometric view showing the Fresnel composite lens of FIG. 3 from a second perspective.

FIG. 5 is a schematic view of the design principles of the Fresnel composite lens of FIG. 4.

FIG. 6 is a schematic view showing the infrared touch control device of FIG. 2 being used.

### DETAILED DESCRIPTION

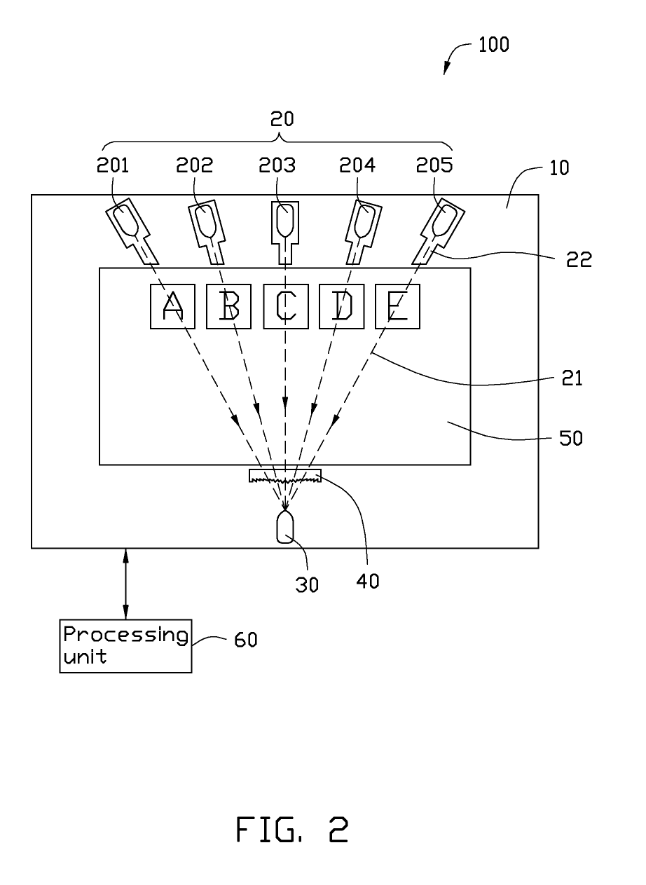

Referring to FIG. 2, an infrared touch control device 100 includes a frame 10, a number of infrared emitters 20, an infrared receiver 30, a Fresnel composite lens 40, a display screen 50, and a processing unit 60. The frame 10 is arranged around the display screen 50 and supports the display screen 50. The infrared emitters 20 are arranged on the frame 10 along at least one side of the display screen 50. The infrared receiver 30 and the Fresnel composite lens 40 are arranged on the frame 10 opposite to the infrared emitters 20. In the embodiment, the Fresnel composite lens 40 and the infrared receiver 30 are arranged on the same side of the display screen 50, with the Fresnel composite lens 40 being arranged between the infrared receiver 30 and the infrared emitters 20.

In use, the processing unit 60 controls the infrared emitters 20 to emit light beams 21 sequentially in cycles. The light beams 21 fall on the Fresnel composite lens 40, and the Fresnel composite lens 40 converges and directs the light beams 21 from the infrared emitters 21 to the infrared receiver 30. In order to make it easier for the infrared receiver 30 to receive the light beams 21, the infrared emitters 20 are all pointed towards the infrared receiver 30, and a number of directional slots 22 equal to the number of the infrared emitters 20 are formed on the frame 10 to achieve this. With such a structure, the light beams 21 can be guided and transmitted along the slots 22, and finally be transmitted directly to the infrared receiver 30.

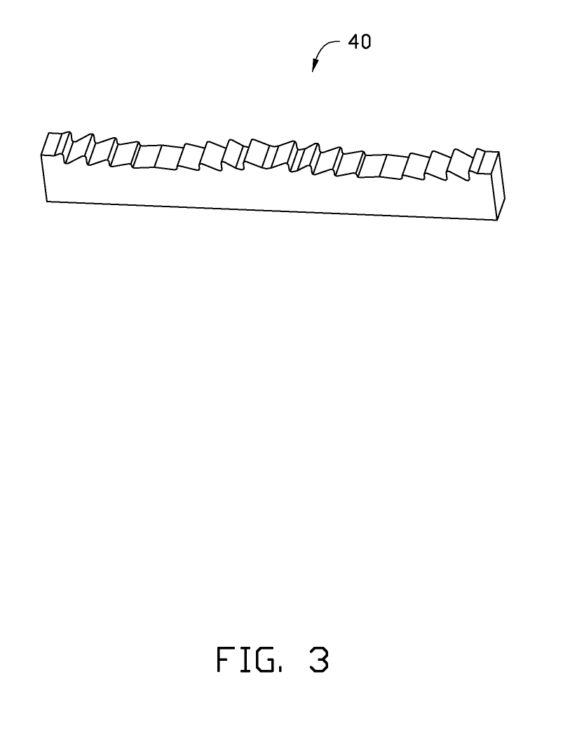

Referring also to FIGS. 3˜4, in the embodiment, the Fresnel composite lens 40 consists of a number of Fresnel lens portions (five Fresnel lens portions 401˜405, for example). Each Fresnel lens portions corresponds to a particular infrared emitter and is configured for converging and directing light beam 21 from a corresponding infrared emitter to the infrared receiver. In the embodiment, the Fresnel composite lens 40 includes a flat side surface facing the infrared emitters, and the Fresnel lens portions 401˜405 focuses the light beams 21 from the respective infrared emitters 20 at a common point located on the infrared receiver 30. In the embodiment, the Fresnel lens portions 401˜405 each have different sizes of surface area for receiving light beams 21, with the width and other proportions of each Fresnel lens portions 401˜405 in the Fresnel composite lens 40 depending upon the angular location and distance of the corresponding infrared emitter 20 relative to the infrared receiver 30.

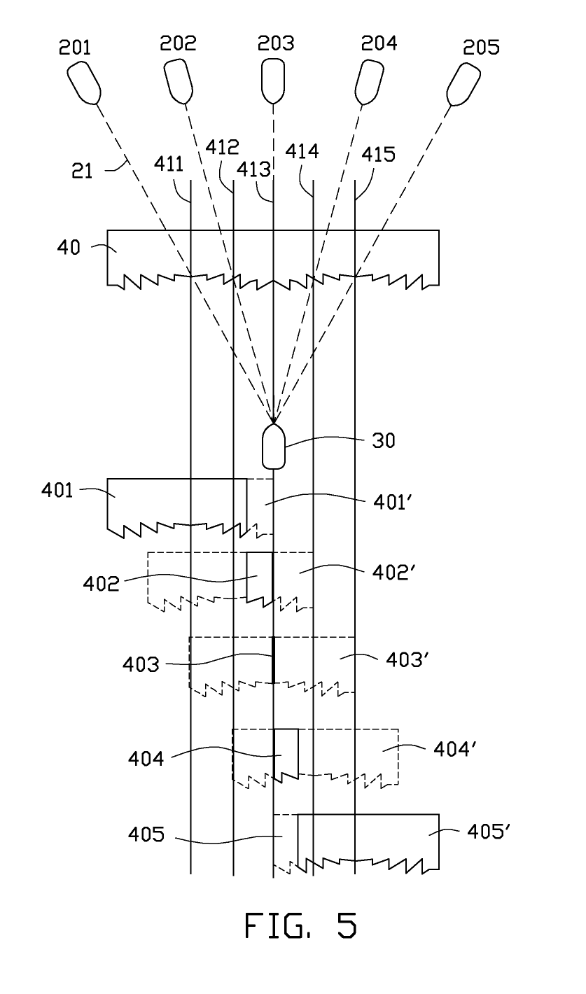

Specifically, referring to FIG. 5, showing an exploded view of the design principles of the Fresnel composite lens 40. In the embodiment, the Fresnel composite lens 40 has a number of parallel optical axes 411˜415 corresponding to the Fresnel lens portions 401˜405. In the embodiment, each Fresnel lens portions 401˜405 is a portion of a Fresnel lens 401′405′, the optical axes 411˜415 are the main optical axes of the Fresnel lenses 401′˜405′ respectively, and the Fresnel lenses 401′˜405′ respectively correspond to the infrared emitters 201˜205.

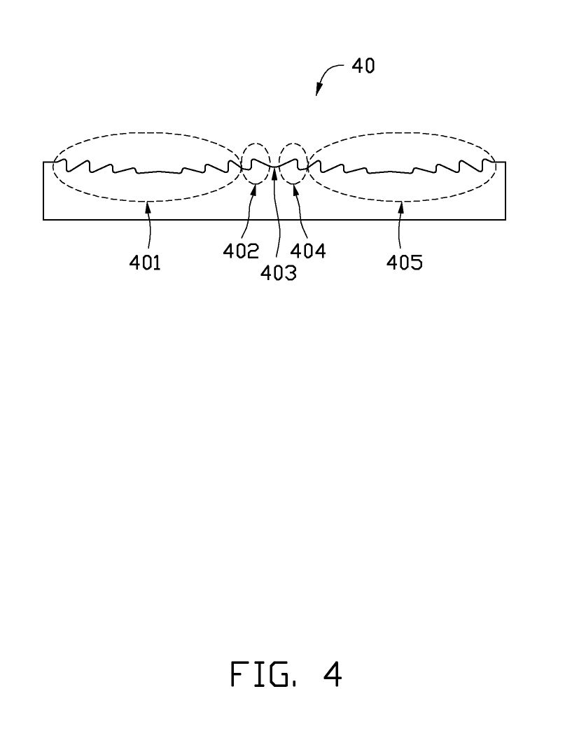

In order to make the light beams 21 emitted by the infrared emitters 201˜205 be received precisely by the infrared receiver 30, the spacing of the Fresnel lenses 401′˜405′ can be pre-adjusted according to the angular location and distance to the corresponding infrared emitter 20 relative to the infrared receiver 30. With such a structure, every light beam 21 can be focused on the infrared receiver 30 by means of the optical effect of each of the Fresnel lenses 401′˜405′.

Where the intensity of the light beams 21 is uniform in strength, the farther the infrared emitter 20 is away from the infrared receiver 30, the weaker the strength of the light beams reaching the infrared receiver 30; and the nearer the infrared emitter 20 to the infrared receiver 30, the stronger the strength of the light beams reaching the infrared receiver 30. In order to facilitate the processing and the analysis of the light beams 21, the strength of the light beams 21 should be approximately equal when they reach the infrared receiver 30. So, the different Fresnel lenses 401′˜405′ need to be shaped according to the angular locations and distances of the infrared emitters 20 relative to the infrared receiver 30. That is, the profile(s) of the Fresnel lenses 401′˜405′ is as shown in FIG. 4, to achieve the Fresnel lens portions 401˜405. Furthermore, the further from the matching infrared emitter, the wider the Fresnel lens portions 401 and 405 must be in the Fresnel composite lens 40. Similarly, the lens portion 403 must have the narrowest width in the Fresnel composite lens 40, as the matching infrared emitter 203 is nearest to the infrared receiver 30. With such a structure, the Fresnel lens portions 401˜405 each have different sizes of surface area for receiving light, thus the light beams 21 are approximately equal in strength when they reach the infrared receiver 30, after the optical affect of the corresponding Fresnel lens portions 401˜405.

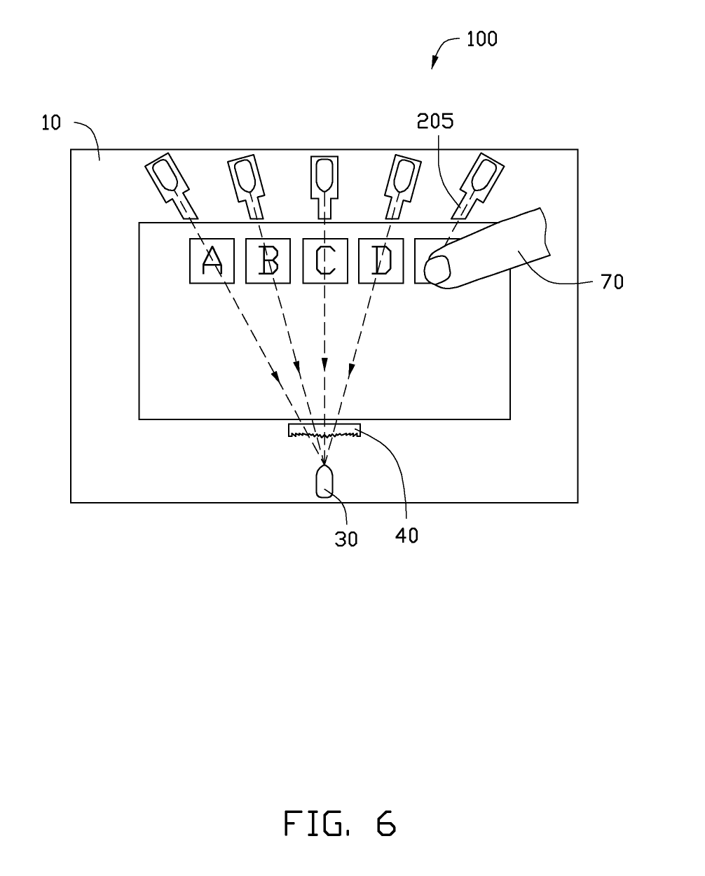

Referring to FIG. 6, the processing unit 60 further controls the display screen 50 to display a number of menu icons, each of which correspond to only one light beam 21 emitted by the infrared emitters 20. In the embodiment, five menu icons A, B, C, D and E, corresponding to the five infrared emitters 201˜205, are shown on the display screen 50. The light beams 21 being emitted sequentially in cycles from the infrared emitters 201˜205 in the order are shown.

In use, for example, when a finger 70 touches the menu icon E, the light beam 21 corresponding to the menu icon E is blocked. During the period of time that the finger 70 is touching the menu icon E, the infrared receiver 30 can not receive any light beam, even though the infrared emitter 205 is emitting light cyclically, which causes the processing unit 60 to determine that the menu icon E has been touched, and to perform a predetermined or default function.

The disclosure may be embodied in other forms without departing from the spirit thereof. The present examples and embodiments are to be considered in all respects as illustrative and not restrictive, and the disclosure is not to be limited to the details given herein.

What is claimed is:

1. An infrared touch control device comprising:
a display screen;
a frame arranged around the display screen;
a plurality of infrared emitters arranged on the frame along a first side of the display screen, the infrared emitters configured for emitting infrared light beams;
a Fresnel composite lens arranged on the frame opposite to the infrared emitters; and
an infrared receiver arranged on the frame at an opposite second side of the display screen, the Fresnel composite lens configured for converging and directing the light beams from the infrared emitters to the infrared receiver, the Fresnel composite lens being arranged between the infrared receiver and the infrared emitters;
wherein the Fresnel composite lens consists of a plurality of Fresnel lens portions having a plurality of parallel optical axes, each Fresnel lens portion having a corresponding optical axis, each Fresnel lens portion corresponding to a particular emitter and configured for converging and directing light from a corresponding infrared emitter to the infrared receiver.

2. The infrared touch control device of claim 1, wherein the Fresnel composite lens and the infrared receiver are arranged on the second side of the display screen.

3. The infrared touch control device of claim 1, wherein the Fresnel lens portions are configured for focusing the light beams from the respective infrared emitters at a common point located on the infrared receiver.

4. The infrared touch control device of claim 1, wherein the Fresnel composite lens includes a flat side surface facing the infrared emitters.

5. The infrared touch control device of claim 1, wherein the Fresnel lens portions each have different sizes of surface area for receiving light beams, with the width and other proportions of each Fresnel lens portions in the composite optical lens depending upon the angular location and distance of the corresponding infrared emitter relative to the infrared receiver.

6. The infrared touch control device of claim 1, wherein the emitters are all pointed towards the receiver, and a number of directional slots equal to the number of the emitters are formed on the frame, to make it easier for the receiver to receive the light beams.

7. A Fresnel composite lens for use in an infrared touch control device comprising a plurality of infrared emitters and an infrared receiver, the Fresnel composite lens comprising a plurality of Fresnel lens portions having a plurality of parallel optical axes, each Fresnel lens portion having a corresponding optical axis, each Fresnel lens portion corresponding to a particular emitter and configured for converging and directing light from a corresponding infrared emitter to the infrared receiver, the Fresnel lens portions configured for focusing the light from the respective infrared emitters at a common point located on the infrared receiver.

8. The Fresnel composite lens of claim 7, wherein the Fresnel composite lens includes a flat side surface.

9. The Fresnel composite lens of claim 7, wherein the Fresnel lens portions each have different sizes of surface area for receiving light beams, with the width and other proportions of each Fresnel lens portions in the composite optical lens depending upon the angular location and distance of the corresponding infrared emitter relative to the infrared receiver.
